(19) United States
(12) Patent Application Publication
(10) Pub. No.: US 2005/0089990 A1
(43) Pub. Date: Apr. 28, 2005

(54) Method of deodorant for kitchen disposal and toilet pipeline

(76) Inventor: Ming-Che Wu, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/690,601

(22) Filed: Oct. 23, 2003

(51) Int. Cl. C12S 9/00

(52) U.S. Cl. 435/264; 435/266; 210/610

(57) ABSTRACT

A method of deodorant for kitchen disposal or toilet pipeline is to prearrange fermentation catalyst at a water inlet with preserved water therein to dissolve a portion of the fermentation catalyst and to flow through a pipeline to the final destination.

### FIELD OF THE INVENTION

This invention relates to a deodorant, and more particularly to a method of using fermentation catalyst to dissolve organism and to dredge the pipeline so as to eliminate clogging and accumulating germs and smelling.

### BACKGROUND OF THE INVENTION

A conventional toilet uses a fermentation tank to collect waste which is mixed with water and drops into the fermentation tank. Upon reaching to the tank, all waste remains at the bottom of the tank over 12 hours. During this time, 60% to 70% of the waste will be kept in the tank and those do not dissolve waste will be excreted.

In order to have a better efficient to process waste, most of the fermentation tanks are designed to separate with partitions into several blocks. The partitions are formed by connecting with the wall on the top or at the bottom thereat in a sequential arrangement. This allows the waste fluid to flow up and down along the partitions in a whirling method, which provides more oxygen into the waste.

With enough oxygen and nutrition (organic compound and non-polar compound) provided, the wall of each partition and the inner wall of the fermentation tank grows with germs to absorb portions of the organic compound and non-polar compound and produces stabilized ammonia, methane etc. while the rest products disperse in the air.

After a while, the dispersed air accumulated in the pipeline produces an odor smell. This situation happens in toilet, kitchen sink and bath tub.

### SUMMARY OF THE INVENTION

It is the primary object of the present invention to provide a method of deodorant for kitchen disposal and toilet pipeline, which can eliminate all odors or any strange smell effectively.

It is another object of the present invention to provide a method of deodorant for kitchen disposal and toilet pipeline, which not only eliminate the odor smelling but also eliminate clogging of the pipeline.

It is a further object of the present invention to provide a method of deodorant for kitchen disposal and toilet pipeline, which is inexpensive in manufacture and easy to maintain.

### BRIEF DESCRIPTION OF THE DRAWINGS

FIG. 1 is a flow chart of the present invention;

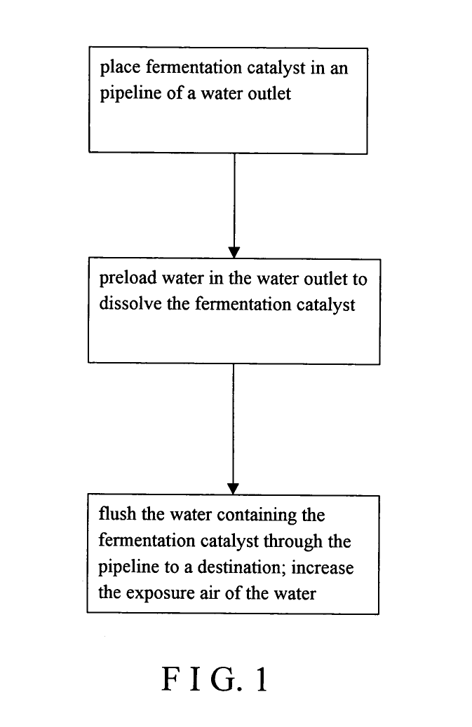

FIG. 2 is a view showing the present invention applied to a toilet; and

FIG. 3 is a view showing the present invention applied to a tank.

### DETAILED DESCRIPTION OF THE PREFERRED EMBODIMENT

A method to eliminate odor smelling from kitchen, toilet and bathtub of the present invention is to use a natural made Bacillus Subtilis as fermentation catalyst, which is packed in a cloth bag. The Bacillus Subtilis will produce metabolism and fermentation catalyst to block germs from growing, which eliminates accumulation of waste in a pipeline. As a result no odor smelling will be produced, nor will the pipeline be clogged. And the method is:
1. to place the fermentation catalyst in a pipeline of an water outlet,
2. to preload water in the water outlet to dissolve the fermentation catalyst, and
3. to flush the water containing the fermentation catalyst through the pipeline.

In this case, each flushing allows the water to mix with oxygen, which increases the exposure air of the water, while the fermentation catalyst within the water flushes out germs and odor smell.

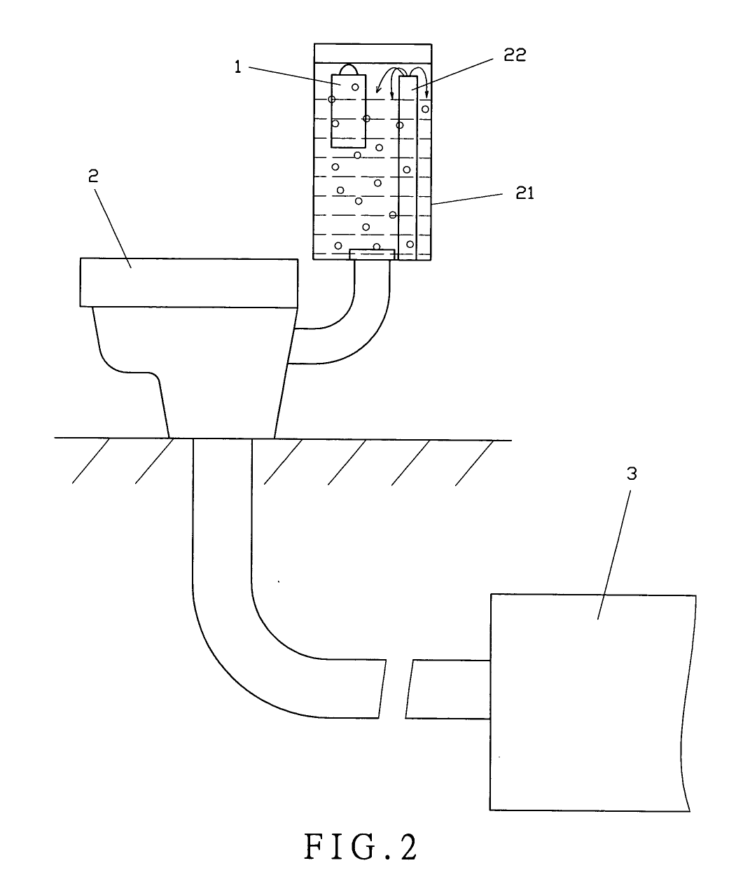

If the invention is applied to a toilet, as shown in FIG. 2, fermentation catalyst 1 is placed in a water tank 21 of a toilet 2. The fermentation catalyst 1 is made in a bag type and hanged on an upper wall with a portion soaking in the water, so that a portion of the fermentation catalyst 1 is dissolved in the water and preserved in the water tank 21. When flushing the toilet 2, the water brings a lot of oxygen with it and flushes the waste to a reservoir 3. The fermentation catalyst 1 will treat the germs continuously.

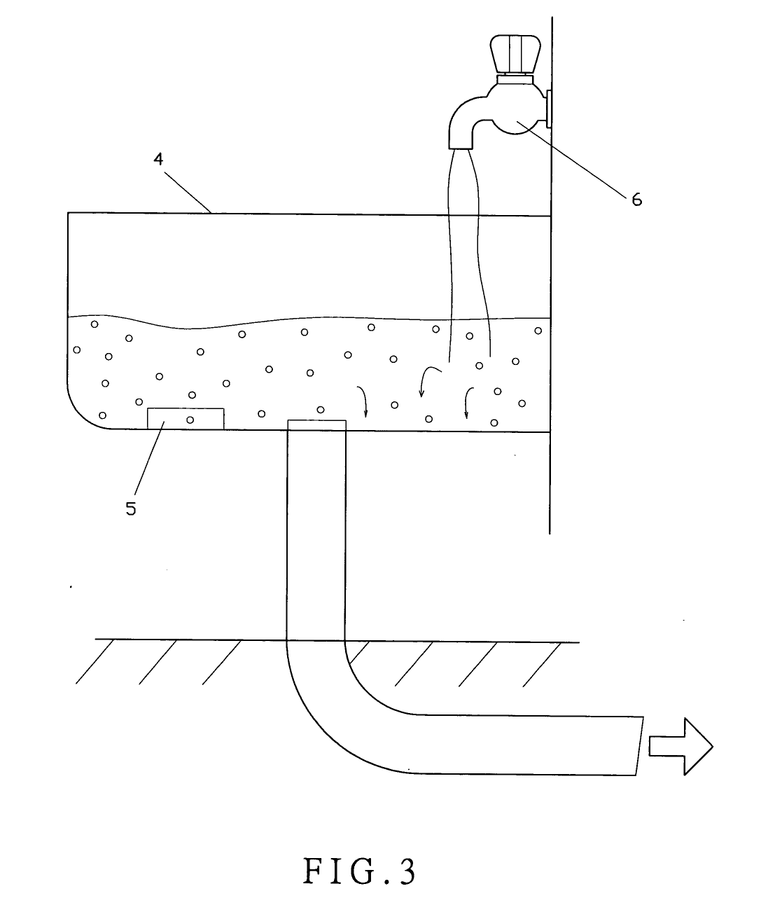

Further, the fermentation catalyst of the present invention may be applied to a kitchen sink 4, as shown in FIG. 3. Fermentation catalyst 5 is made in a tablet form, which may also be in powder or fluid type. The fermentation catalyst 5 will do a first deodorant process when a water faucet 6 is turned on. The water flushes the pipeline, and the fermentation catalyst 5 will do a second deodorant process and clean any residue left on the inner wall of the pipeline.

1. A method of deodorant for kitchen disposal and toilet pipeline comprising a first step being to place a fermentation catalyst in a pipeline of a water outlet, a second step being to preload water in said water outlet to dissolve said fermentation catalyst, and a third step being to flush said water containing said fermentation catalyst through said pipeline to a destination.
